(19) United States
(12) Patent Application Publication
(10) Pub. No.: US 2024/0284969 A1
(43) Pub. Date: Aug. 29, 2024

(54) SMOKING TIP

(71) Applicants: Malan Dimopoulos, Somerville (AU); Greg Dimopoulos, Somerville (AU)

(72) Inventors: Malan Dimopoulos, Somerville (AU); Greg Dimopoulos, Somerville (AU)

(21) Appl. No.: 18/572,837

(22) PCT Filed: Jun. 21, 2021
(86) PCT No.: PCT/AU2021/050645

§ 371 Date: Dec. 21, 2023

(30) Foreign Application Priority Data
Jun. 22, 2020 (AU) 2020902062

(51) Int. Cl. A24D 3/04; A24D 3/06; A24D 3/10; B32B 5/02; B32B 29/02

(52) U.S. Cl. CPC A24D 3/04; A24D 3/062; A24D 3/10; B32B 5/022; B32B 29/02; B32B 2250/02; B32B 2262/062; B32B 2307/724; B32B 2307/7376

(57) ABSTRACT

The present invention relates to a smoking tip, a filter sheet for forming a smoking tip, and a booklet for forming smoking tips. In one aspect of the present invention, a filter sheet comprises: a sheet having a fabric layer thereon: wherein the sheet is rollable to form a smoking tip, and the fabric layer, when the sheet is rolled, forms a filter for the smoking tip. In another aspect of the present invention, a booklet comprises: a plurality of sheets, each sheet having a fabric layer thereon; wherein each sheet is rollable to form a smoking tip, and the fabric layer, when the sheet is rolled, forms a filter for the smoking tip. In another aspect of the present invention, a smoking tip comprises: a roll with a non-woven fabric material therein, wherein the non-woven fabric material forms a filter for the smoking tip.

### FIELD OF THE INVENTION

The invention relates to a smoking tip, a filter sheet for forming a smoking tip and a booklet for forming smoking tips. Preferred embodiments of the invention relate to a smoking tip for cannabis.

### BACKGROUND

An example of an existing smoking tip for is formed from a cardboard sheet that is rolled into a cigarette paper containing the cannabis. Another example of an existing filter is a cylindrical cotton tip/flute about which the cigarette paper containing the cannabis is rolled. While these existing smoking tips would be suitable for smoking tobacco, these tips are not suitable for smoking cannabis due to the very high filtration characteristics, which allows a small percentage of smoking material therethrough.

In this context, there is a need for improved smoking tip.

### SUMMARY OF THE INVENTION

According to an aspect of the present invention, there is provided a filter sheet comprising: a sheet having a fabric layer thereon; wherein the sheet is rollable to form a smoking tip, and the fabric layer, when the sheet is rolled, forms a filter for the smoking tip.

According to another aspect of the present invention, there is provided a booklet comprising: a plurality of sheets, each sheet having a fabric layer thereon; wherein each sheet is rollable to form a smoking tip, and the fabric layer, when the sheet is rolled, forms a filter for the smoking tip.

The sheet may be a paper sheet or a sheet of cardboard. The sheet may, for example, be formed of paper card. In other examples, the sheet may be made from a plant-based material.

The fabric layer may comprise a non-woven material. The non-woven material may be a non-woven cotton material. The fabric layer may, for example, be cotton spunlace non-woven fabric.

The sheet and the fabric layer may comprise non-bleached natural materials.

The fabric layer may have a thickness of between 10 gsm and about 100 gsm. The fabric layer may, for example, have a thickness of one of: about 40 gsm; and about 80 gsm.

The fabric layer may be adhered onto a respective one of the plurality of sheets. The fabric layer may, for example, be laminated on a respective one of the plurality of sheets.

According to another aspect of the present invention, there is provided a smoking tip comprising: a roll with a non-woven fabric material therein, wherein the non-woven fabric material forms a filter for the smoking tip.

The non-woven fabric material may be adhered to a sheet that forms the roll. Preferably, the non-woven fabric is laminated to the sheet that forms the roll.

The roll may include an air gap of up to about 90%. Preferably, the air gap is between about 30% to 70%.

It will be appreciated that the aspects of the invention and their respective features can be used in conjunction, interchangeably and/or independently, and reference to separate aspects is not intended to be limiting.

### BRIEF DESCRIPTION OF THE DRAWINGS

The invention will now be described, by way of non-limiting example only, with reference to the accompanying drawings, in which:

FIG. 1 shows a booklet according to an embodiment of the present invention;

FIG. 2 shows a smoking tip according to an embodiment of the present invention;

FIG. 3A shows a filter sheet according to an embodiment of the present invention;

FIG. 3B shows the filter sheet of FIG. 3A in a partially rolled state; and

FIG. 3C shows the filter sheet of FIG. 3A in a rolled state.

### DETAILED DESCRIPTION

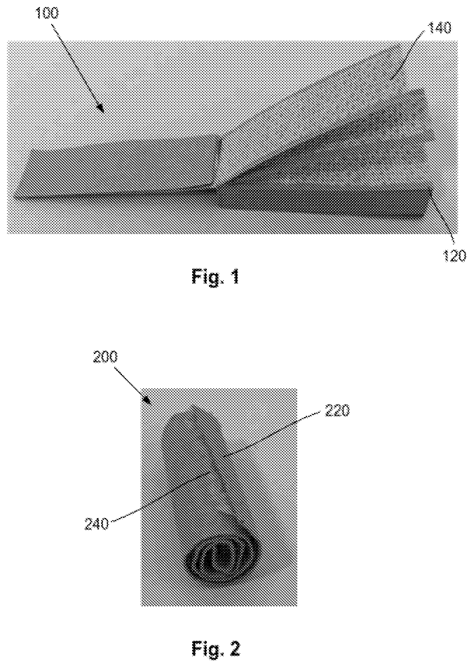

FIG. 1 shows a booklet 100 according to an embodiment of the present invention.

The booklet 100 comprises a plurality of sheets of cardboard 120. The sheets may alternatively be sheets of paper or any backing material that is natural or as close to naturally processed as possible. The sheets of the booklet are of a material that is rollable to form a smoking tip. The smoking tip according to preferred embodiments of the invention has particular application for smoking cannabis.

One booklet 100 may have between about 20 to 50 sheets. The sheets 120 of the booklet have a substantially rectangular shape for forming a cylindrical or tube-shaped smoking tip. In other embodiments, the sheet have a substantially trapezoidal shape or arc-shaped that is rollable to form a substantially conical smoking tip. Other sheet shape for the booklet are possible. In addition, other materials for forming the sheets of the booklet are also possible that are rollable and provide some rigidity to the smoking tip when rolled are possible.

Each sheet 120 of the booklet 100 is tearable from the booklet 100. By way of example, the booklet 100 may have perforated sections that attach each sheet to a spine of the booklet 120. In particular, each sheet 120 is attached to the spine of the booklet by a perforated section, and is tearable from the booklet 100 about the perforated section.

On each sheet 120 of the booklet, there is provided a fabric layer 140. The fabric layer 140 spans the length of the sheet and is narrower than the sheet 120. In other embodiments, the fabric layer is the same size, in width and length, as the sheet on which it is provided. Alternatively, in other examples, the fabric layer is larger in size, in width and/or in length, than the sheet on which it is provided. The fabric layer is a layer of synthetic fibres. The fabric layer 140 in this embodiment is a non-woven cotton material. The fabric layer 140 acts as a filter of the smoking tip when the smoking tip is formed upon rolling the sheet 120. In other embodiments, the fabric layer may be cellulose crepe paper, cellulose acetate, hemp, other natural filter material, or other non-natural or artificial filter material.

Non-woven material allows for the density and shape of the filter for the smoking tip to be controlled. The non-woven material filters out some of the burn associated with smoking with a sheet, such as a paper card. The non-woven material provides a filtering medium for the smoking tip with controlled uniform density thickness. The non-woven material is able to take on the shape of the sheet by closely being adhered to the sheet backing so that the non-woven material becomes part of the sheet. The non-woven material would not separate from the sheet as a user rolls and/or folds the sheet. The user would accordingly be able to fold and roll the sheet to form the traditional M-shape centre (or W-shape centre), a cannabis leaf shape centre, or any other shape. The material allows more air flow free draw allowing more of the medicinal cannabis through to the end user and more smoke for the tobacco end user which may be sometimes preferred by the user.

The non-woven material has a thickness of between 10 gsm and about 100 gsm. In other examples, the non-woven material has a thickness that is greater than 100 gsm. The larger thickness of non-woven materials could be used for larger novelty smoking articles for example. The non-woven material in a preferred embodiment comprises a non-bleached natural cotton non-woven fabric with a thickness of about 40 gsm. The non-woven material has a series of apertures, which correspond to needle-punched holes. In other embodiments, the non-woven material comprises a non-perforated material such as a 100% cotton non-woven material.

The fabric layer 140 is adhered onto each sheet 120 of the booklet 100. In particular, the fabric layer 140 is laminated onto each sheet 120. The lamination process utilises a lamination machine in which material from a roll of sheet material (e.g. paper card material) and material from a roll of non-woven material (e.g. non-woven cotton material) undergoes a lamination process. The roll of sheet material will feed through to meet the roll of non-woven material which will then be adhered to each other using an adhesive, such as a natural polyvinyl alcohol (PVA) adhesive in a water soluble solution. The adhesive may be any suitable adhesive preferably natural or as close to naturally manufactured as possible. The adhered product of sheet backing and non-woven material will then be fed through to a finished roll. The roll will then be manufactured into a finished booklet, or a prerolled smoking tip, or a smoking kit comprising of smoking paper smoking tips filters and any other smoking style product added to the smoking kit. In other examples, the fabric layer may be embedded in the sheet of the booklet. In yet other examples, the fabric layer may be loosely provided on the sheet of the booklet.

An end portion of the smoking tip is insertable into a roll of smoking material, which in preferred embodiments comprises cannabis or tobacco, while an opposite end portion would be insertable into the persons mouth for consumption of the smoking material.

When the smoking tip is formed, there is an air gap defined by the fabric layer 120 to allow a flow of particles of smoking material. The air gap would be up to about 90%. Preferably, the air gap is between about 30% to 70%. In particular, when a sheet 120 of the booklet 100 is rolled to form a smoking tip, the sheet with the fabric layer thereon form a spiral. As a result, the smoking tip would have multiple layers of sheet portions with a portion of the fabric layer 140 between adjacent layers of the sheet portions. Each adjacent sheet layer in the roll forming the smoking tip would be separated from an adjacent sheet layer by a portion of the fabric layer. The spacing between adjacent layers of sheet portions in the roll by the portions of sheet layer create the air gap in the roll. The user can roll the sheet depending on how much smoke they want allowed through the smoking tip. If the user wants less smoke through the smoking tip, the user would create a tight roll with less of an air gap between layers of the roll. On the other hand, if the user wants more smoke through the smoking tip, the user would create a loose roll with more of an air gap between layers of the roll. For even more smoke draw, the user could cut the sheet into a smaller sheet length to be rolled into a smoking tip with fewer layers. The filtered tip allows the user to control the amount of smoke they draw. Accordingly, the sheet allows for more versatility that is not provided by any of the conventional prerolled filtered tips. In particular, the amount of filtration or smoke draw provided by conventional prerolled tips is not adjustable by the user.

FIG. 2 shows a smoking tip 200 according to an embodiment of the invention. The smoking tip 200 may be formed from a sheet of the booklet 100 described with reference to FIG. 1. In other embodiments, the smoking tip 200 may be pre-rolled.

The smoking tip 200 has a substantially cylindrical shape. As previously described. The smoking tip may have other shapes such as a cone shape for example.

The smoking tip 200 is formed of a roll of sheet material 220 that may be a cardboard material or a paper material. The smoking tip 200 has fabric material 240 contained within the roll that provides some filtration of the smoking material as it is smoked by the user. The fabric material 240 comprises non-woven cotton material. The fabric material forms an air gap for the smoking tip. The air gap may be up to about 90%, providing a filtration of up to about 10%. The smoking tip according to preferred embodiments allow for an airflow or smoke draw of at least 0.75 m/s through the smoking tip. The airflow or smoke draw may, in some examples, be up to 3.00 m/s and, in other examples, greater than 3.00 m/s.

It will be appreciated that the booklet as 100 described above effectively provides a plurality of filter sheets that can be used for form the smoking tip 200, in a convenient transportable format. However, in alternative embodiments, loose filter sheets may be provided separately, without being bound into a booklet.

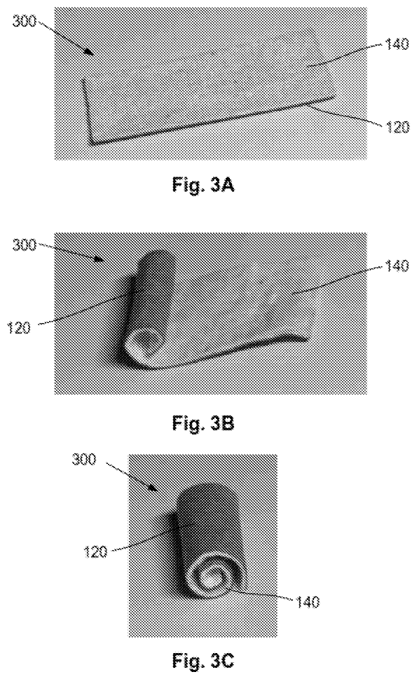

FIG. 3A shows a filter sheet 300 according to an embodiment of the invention. The filter sheet comprises a sheet 120 having a fabric layer 140 thereon. The sheet 120 is rollable to form a smoking tip 200 as discussed above, with FIG. 3B showing the filter sheet 300 in a partially rolled state, and FIG. 3C showing the filter sheet 300 in a rolled state. The fabric layer 140, when the sheet 120 is rolled, forms a filter for the smoking tip 200.

It will be appreciated that embodiments of the filter sheet 300 may be constructed from the same materials and used in generally the same manner as described above for the sheets 120 of the booklet 100. Accordingly, it will be understood that the features of the sheets 120 of the booklet 100 and their performance when used to provide a smoking tip 200 as discussed herein will also be applicable to filter sheets 300 that may be provided in a separate, loose form.

In preferred embodiments of the filter sheet 300, the sheet 120 may be formed of paper card that is suitable for allowing the sheet 120 to be rolled, although other materials may be used as discussed above.

The fabric layer 140 may comprise non-woven material, and in the specific embodiment shown in FIGS. 3A to 3C, the fabric layer 140 is cotton spunlace non-woven fabric, although other materials may be used as discussed above. The fabric layer 140 may have a thickness of between 10 gsm and about 100 gsm, and in specific embodiment shown in FIGS. 3A to 3C, the fabric layer has a thickness of about 80 gsm.

Preferably, the sheet 120 and the fabric layer 140 comprise non-bleached natural materials.

In any event, sheets 120 of the booklet 100 or loose filter sheets 300 can advantageously allow a user to roll their own smoking tip including a filter that can provide a more desirable filtering performance in particular smoking applications, such as for smoking cannabis. Moreover, the user can customize the filtering performance to suit their preferences, by modifying how the smoking tip is rolled.

To test the effectiveness of the smoking tips of preferred embodiments of the present invention, air flow tests were conducted using the smoking tips of preferred embodiments and some conventional tips or tips that use cotton material (not non-woven). Each sample tip to be tested for velocity with negative pressure of approximately 4900 Pa placed on one side of the filter. Each tip that was tested was placed in a 16 mm tube. The velocity of air flow through the tip in the tube was measured with a hot wire anemometer probe. The probe was inserted into the pipe and ambient air was drawn past probe and into tube where tip was fitted. The results of the tests are set out in the tables below. Table 1 shows the velocity results of sample smoking tips according to the preferred embodiments of the present invention, each of which are rolls of non-woven cotton material having a 40 gsm thickness on a paper card backing. Table 2 shows the velocity results of sample smoking tips with cotton material rolled with a paper card backing. Table 3 shows the velocity results of sample smoking tips with strips cotton material portions that are spaced apart from each other and that are rolled with a paper board backing to create air gaps in the tip. Table 4 shows the velocity results of sample smoking tips of a non-woven cotton material bunched to form a prerolled tip.

TABLE 1
Velocity results of sample smoking tips each of which are rolls
of non-woven cotton material having a 40 gsm thickness on
a paper card backing (filter average diameter: 7.25 mm)

| | | | | | Velocity |
|---|---|---|---|---|---|
| | | | | volumetric | through |
| | Velocity | Correction | Corrected | flow rate | the filter |
| Sample | (m/s) | factor | value | (L/s) | (m/s) |
| 1.1 | 2.26 | 0.05 | 2.31 | 0.46 | 14.00 |
| 1.2 | 2.1 | 0.01 | 2.11 | 0.42 | 12.78 |
| 1.3 | 1.6 | −0.02 | 1.58 | 0.32 | 9.57 |
| 1.4 | 2.13 | 0.01 | 2.14 | 0.43 | 12.97 |
| 1.5 | 0.75 | 0.01 | 0.76 | 0.15 | 4.60 |
| 1.6 | 1.55 | −0.01 | 1.54 | 0.31 | 9.33 |
| 1.7 | 1.76 | −0.02 | 1.74 | 0.35 | 10.54 |
| 1.8 | 1.56 | −0.01 | 1.55 | 0.31 | 9.39 |

TABLE 2
Velocity results of sample smoking tips with cotton material rolled
with a paper card backing (filter average diameter: 6.5 mm)

| | | | | | Velocity |
|---|---|---|---|---|---|
| | | | | volumetric | through |
| | Velocity | Correction | Corrected | flow rate | the filter |
| Sample | (m/s) | factor | value | (L/s) | (m/s) |
| 2.1 | 0.23 | 0 | 0.23 | 0.046 | 1.39 |
| 2.2 | 0.25 | 0 | 0.25 | 0.050 | 1.51 |
| 2.3 | 0.24 | 0 | 0.24 | 0.048 | 1.45 |
| 2.4 | 0.38 | −0.01 | 0.37 | 0.074 | 2.24 |
| 2.5 | 0.21 | 0 | 0.21 | 0.042 | 1.27 |
| 2.6 | 0.05 | 0 | 0.05 | 0.010 | 0.30 |
| 2.7 | 0.22 | 0 | 0.22 | 0.044 | 1.33 |
| 2.8 | 0.03 | 0 | 0.03 | 0.006 | 0.18 |

TABLE 3
Velocity results of sample smoking tips with strips cotton
material portions that are spaced apart from each other
and that are rolled with a paper board backing to create
air gaps in the tip (filter average diameter: 7.0 mm)

| | | | | | Velocity |
|---|---|---|---|---|---|
| | | | | volumetric | through |
| | Velocity | Correction | Corrected | flow rate | the filter |
| Sample | (m/s) | factor | value | (L/s) | (m/s) |
| 3.1 | 0.18 | 0 | 0.18 | 0.036 | 1.09 |
| 3.2 | 0.22 | 0 | 0.22 | 0.044 | 1.33 |
| 3.3 | 0.13 | 0 | 0.13 | 0.026 | 0.79 |
| 3.4 | 0.43 | −0.01 | 0.42 | 0.084 | 2.54 |
| 3.5 | 0.18 | 0 | 0.18 | 0.036 | 1.09 |
| 3.6 | 0.14 | 0 | 0.14 | 0.028 | 0.85 |
| 3.7 | 0.06 | 0 | 0.06 | 0.012 | 0.36 |

TABLE 4
Velocity results of sample smoking tips of a cotton
(non-woven) material bunched to form a prerolled
tip (filter average diameter: 6.0 mm)

| | | | | | Velocity |
|---|---|---|---|---|---|
| | | | | volumetric | through |
| | Velocity | Correction | Corrected | flow rate | the filter |
| Sample | (m/s) | factor | value | (L/s) | (m/s) |
| 4.1 | 0.5 | −0.01 | 0.49 | 0.099 | 2.97 |
| 4.2 | 0.58 | 0 | 0.58 | 0.117 | 3.51 |
| 4.3 | 0.43 | −0.01 | 0.42 | 0.084 | 2.54 |
| 4.4 | 0.52 | −0.01 | 0.51 | 0.103 | 3.09 |
| 4..5 | 0.39 | −0.01 | 0.38 | 0.076 | 2.30 |
| 4.6 | 0.58 | 0 | 0.58 | 0.116 | 3.51 |
| 4.7 | 0.73 | 0.01 | 0.74 | 0.149 | 4.48 |
| 4.8 | 0.42 | −0.01 | 0.41 | 0.082 | 2.48 |

From these tables, it can be seen that smoking tips according to preferred embodiments of the present invention have a significantly higher airflow compared to the tested samples. In particular, samples of preferred embodiments of the present invention according to Table 1 had a measured velocity of between about 0.75 m/s and about 2.26 m/s. In contrast, the sample tips of Table 2 had a measured velocity from about 0.05 m/s to 0.38 m/s, the sample tips of Table 3 had a measured velocity from about 0.06 m/s to 0.43 m/s, while the sample tips of Table 4 had a measured velocity from about 0.39 m/s to 0.73 m/s.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

1. A filter sheet comprising:
a sheet having a fabric layer thereon;
wherein the sheet is rollable to form a smoking tip, and the fabric layer, when the sheet is rolled, forms a filter for the smoking tip.

2. The filter sheet of claim 1, wherein the fabric layer comprises non-woven material.

3. The filter sheet of claim 2, wherein the fabric layer is cotton spunlace non-woven fabric.

4. The filter sheet of claim 1, wherein the fabric layer has a thickness of between 10 gsm and about 100 gsm.

5. The filter sheet of claim 4, wherein the fabric layer has a thickness of one of:
about 40 gsm; and
about 80 gsm.

6. The filter sheet of claim 1, wherein the fabric layer is adhered onto the sheet.

7. The filter sheet of claim 1, wherein the fabric layer is laminated onto the sheet.

8. The filter sheet of claim 1, wherein the sheet is formed of paper card.

9. The filter sheet of claim 1, wherein the sheet and the fabric layer comprise non-bleached natural materials.

10. A booklet comprising:
a plurality of sheets, each sheet having a fabric layer thereon;
wherein each sheet is rollable to form a smoking tip, and the fabric layer, when the sheet is rolled, forms a filter for the smoking tip.

11. The booklet of claim 10, wherein the fabric layer comprises non-woven material.

12. The booklet of claim 11, wherein the fabric layer is cotton spunlace non-woven fabric.

13. The booklet of 10, wherein the fabric layer has a thickness of between 10 gsm and about 100 gsm.

14. The booklet of claim 13, wherein the fabric layer has a thickness of one of:
about 40 gsm; and
about 80 gsm.

15. The booklet of claim 10, wherein the fabric layer is adhered onto a respective one of the plurality of sheets.

16. The booklet of claim 10, wherein the fabric layer is laminated onto a respective one of the plurality of sheets.

17. The booklet of claim 10, wherein each sheet is formed of paper card.

18. A smoking tip comprising:
a roll with a non-woven fabric material therein, wherein the non-woven fabric material forms a filter for the smoking tip.

19. The smoking tip of claim 18, wherein the non-woven fabric material is laminated to a sheet that forms the roll.

20. The smoking tip of claim 18, wherein the roll includes an air gap of up to about 90%.
